(19) United States
(12) Patent Application Publication
(10) Pub. No.: US 2011/0164965 A1
(43) Pub. Date: Jul. 7, 2011

(54) STEAM TURBINE STATIONARY COMPONENT SEAL

(75) Inventors: Sean Allen Smith, Guilderland, NY (US); James Peter Anderson, Clifton Park, NY (US); Vishwas Kumar Pandey, Bangalore (IN); Prashant Prabhakar Sankolli, Bangalore (IN)

(73) Assignee: GENERAL ELECTRIC COMPANY, Schenectady, NY (US)

(21) Appl. No.: 12/652,803

(22) Filed: Jan. 6, 2010

(51) Int. Cl. F01D 25/24; F16J 15/34

(52) U.S. Cl. 415/182.1; 277/399

(57) ABSTRACT

A steam turbine and a seal member between stationary components of a steam turbine are disclosed. The seal member is annular, with a cross-section having an elongated seal member and bulbous ends that are adapted to be inserted into grooves in the stationary components to form point seals between the bulbous ends and axial faces of the grooves. The bulbous ends are designed to rotate with respect to the axial faces of the annular grooves and the elongated member is designed to flex to maintain the point seals in response to a realignment of the components.

### BACKGROUND OF THE INVENTION

The subject matter disclosed herein relates generally to steam turbines and stationary components within steam turbines. More specifically, the present invention relates to a seal activated by a pressure differential between the stationary components of a steam turbine.

In a steam turbine, the greater the number and magnitude of steam leakage paths, the greater the losses of efficiency of the steam turbine. One challenge in designing such seals involves the fact that forces inside the steam turbine, such as those incurred by heating or cooling, may cause different components to expand or contract at different rates. Moreover, it is often difficult to create seals which not only increase the efficiency of the steam turbine but also increase the ability to service and repair various parts of the turbine as well as to create known repeatable boundary conditions for such parts.

### BRIEF DESCRIPTION OF THE INVENTION

A steam turbine and a seal member between stationary components of a steam engine are disclosed. The seal member is annular, with a cross-section having an elongated seal member and bulbous ends that are adapted to be inserted into grooves in the stationary components to form point seals between the bulbous ends and axial faces of the grooves. The bulbous ends are designed to rotate with respect to the axial faces of the annular grooves and the elongated member is designed to flex to maintain the point seals in response to a realignment of the components.

A first aspect of the invention provides a steam turbine comprising: a first component, the first component having a radial surface with an annular groove; a second component, the second component having an opposing radial surface in opposition to the radial surface of the first component, the opposing radial surface having an opposing annular groove; and a seal member that is independent of the first and second components, the seal member being annular and having a cross section comprising an elongated seal member with first and second bulbous ends, the bulbous ends being adapted to be inserted into the annular groove and opposing annular groove to form a first point seal between the first bulbous end and an axial face of the annular groove and a second point seal between the second bulbous end and an axial face of the opposing annular groove.

A second aspect of the invention provides an annular seal member used in a steam turbine, the annular seal member having a cross section, the annular seal member comprising: an elongated body; a first bulbous end coupled to the elongated body, the first bulbous end being adapted to be inserted into an annular groove in a radial surface of a first component; and a second bulbous end coupled to the elongated body, the second bulbous end being adapted to be inserted into an opposing annular groove in an opposing radial surface of a second component, the opposing radial surface being in opposition to the radial surface of the first component, wherein the elongated body, the first bulbous end and the second bulbous end are independent of the first and second components, and wherein a contact between the first bulbous end and an axial face of the annular groove forms a first point seal between the first bulbous end and the axial face of the annular groove and wherein a second contact between the second bulbous end and an axial face of the opposing annular groove forms a second point seal between the second bulbous end and the axial face of the opposing annular groove.

### BRIEF DESCRIPTION OF THE DRAWING

These and other features of the disclosure will be more readily understood from the following detailed description of the various aspects of the invention taken in conjunction with the accompanying drawing that depict various aspects of the invention, in which:

FIG. 1 shows a perspective partial cut-away illustration of a conventional gas or steam turbine;

FIG. 2 shows a fragmentary cross-sectional view of a portion of a steam turbine illustrating various stationary and rotational parts thereof;

FIG. 3 shows a partial cut-away illustration of annular components of a steam turbine;

FIG. 4 shows a cross section of a seal member between annular components of a steam turbine;

FIG. 5 shows a cross section of a seal member between annular components of a steam turbine under loading; and

FIG. 6 shows a cross section, illustrating rotation of a seal member under stress;

It is noted that the drawing is not to scale. The drawing is intended to depict only typical aspects of the invention, and therefore should not be considered as limiting the scope of the invention.

### DETAILED DESCRIPTION OF THE INVENTION

As indicated above, aspects of the invention relate to a steam turbine and a seal member between stationary components of a steam turbine. The seal member is annular, with a cross-section having an elongated seal member and bulbous ends that are adapted to be inserted into grooves in the stationary components to form point seals between the bulbous ends and axial faces of the grooves. The bulbous ends are designed to rotate with respect to the axial faces of the annular grooves and the elongated member is designed to flex to maintain the point seals in response to a realignment of the components.

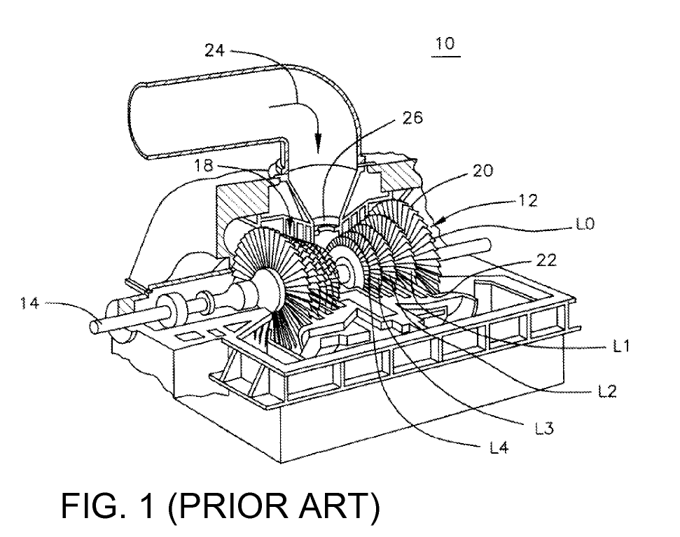

Referring to the drawings, FIG. 1 shows a perspective partial cut-away illustration of a multiple stage, steam turbine 10. Turbine 10 may be a condensing steam turbine or a non-condensing steam turbine. Turbine 10 includes a rotating shaft 12 that includes a rotating shaft 14 and a plurality of axially spaced rotor wheels 18. A plurality of rotating blades 20 are mechanically coupled to each rotor wheel 18. More specifically, blades 20 are arranged in rows that extend circumferentially around each rotor wheel 18. A plurality of stationary vanes 22 extends circumferentially around shaft 14, and the vanes are axially positioned between adjacent rows of blades 20. Stationary vanes 22 cooperate with blades 20 to form a stage and to define a portion of a steam flow path through turbine 10.

In operation, gas or steam 24 enters an inlet 26 of turbine 10 and is channeled through stationary vanes 22. Vanes 22 direct gas or steam 24 downstream against blades 20. Gas or steam 24 passes through the remaining stages imparting a force on blades 20 causing shaft 14 to rotate. At least one end of turbine 10 may extend axially away from rotating shaft 12 and may be attached to a load or machinery (not shown) such as, but not limited to, a generator, and/or another turbine.

In one embodiment, turbine 10 may include five stages. The five stages are referred to as L0, L1, L2, L3 and L4. Stage L4 is the first stage and is the smallest (in a radial direction) of the five stages. Stage L3 is the second stage and is the next stage in an axial direction. Stage L2 is the third stage and is shown in the middle of the five stages. Stage L1 is the fourth and next-to-last stage. Stage L0 is the last stage and is the largest (in a radial direction). It is to be understood that five stages are shown as one example only, and each turbine may have more or less than five stages. Also, as will be described herein, the teachings of the invention do not require a multiple stage turbine.

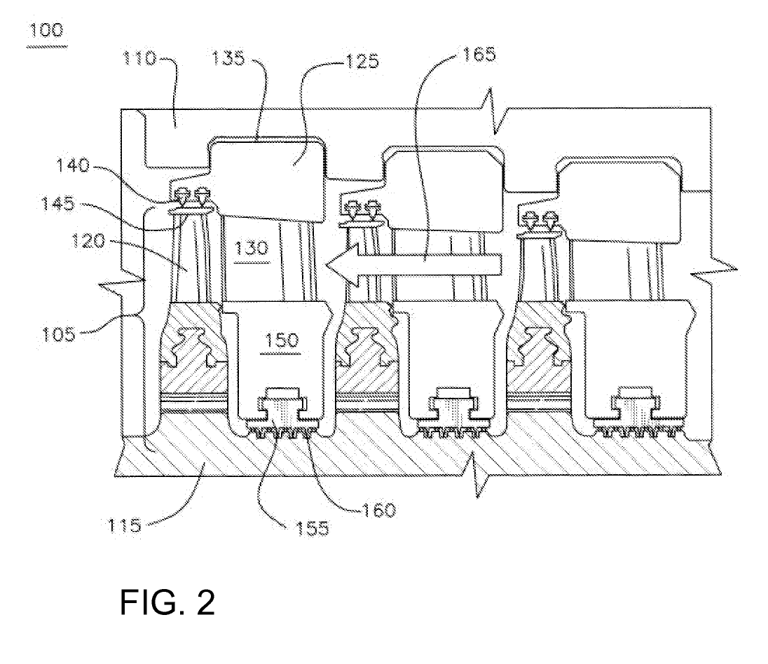

Referring now to FIG. 2, there is illustrated a portion 100 of steam turbine 10 (FIG. 1) having a rotary component 105 and a stationary component 110. Rotary component 105 includes, for example a rotor 115 mounting a plurality of circumferentially spaced buckets 120 at spaced axial positions along the rotor forming parts of the various turbine stages. Stationary component 110 may include a plurality of diaphragms 125 mounting partitions 130 defining nozzles which, together with respective buckets, form the various stages of steam turbine 100. As illustrated in FIG. 2, an outer ring 135 of diaphragm 125 carries one or more rows of seal teeth 140 for sealing with shrouds or covers 145 adjacent the tips of buckets 120. Similarly, an inner ring 150 of diaphragm 125 mounts an arcuate seal segment 155. The seal segment has radially inwardly projecting high-low teeth 160 for sealing with rotor 115. Similar seals are provided at the various stages of steam turbine 100 as illustrated and the direction of the steam flow path is indicated by the arrow 165.

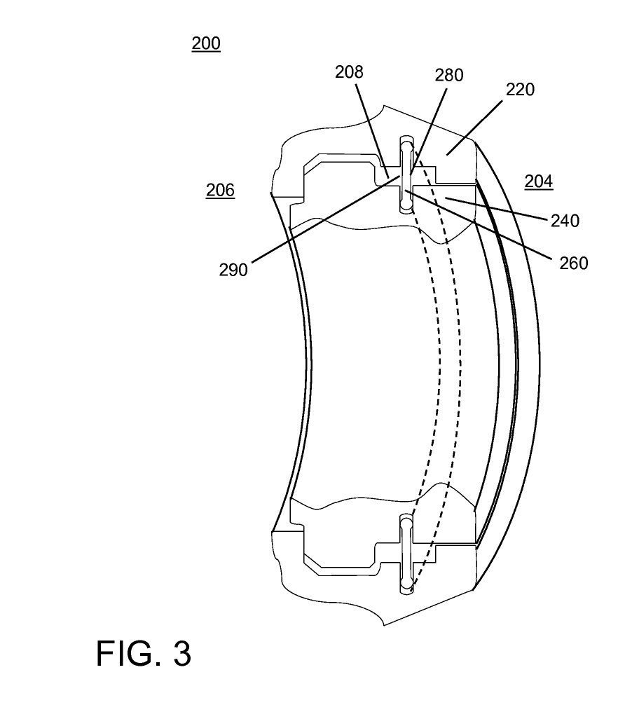

Referring now to FIG. 3, there is illustrated an annular portion 200 of steam turbine 10 (FIG. 1), having a higher pressure region 204, a lower pressure region 206, and a pressure isolation area 208. Although, labeled as higher pressure region 204 and lower pressure region 206, it should be understood by those skilled in the art that embodiments could exist in which higher pressure region 208 has a pressure that is lower than that of lower pressure region 206. Similarly, while it is envisioned that the pressure of pressure isolation area 208 would be intermediate to that of higher pressure region 204 and lower pressure region 206, embodiments may exist in which the pressure of pressure isolation area 208 may be either greater than or less than both higher pressure region 204 and lower pressure region 206 during operation of steam turbine 10.

In any case, annular portion 200 has a first component 220 and a second component 240, both of which are annular. Annular portion 200 also has a seal member 260 between first component 220 and second component 240, which is also annular. Seal member 260 serves to preserve a pressure differential between higher pressure region 204 and an area having a different pressure, such as pressure isolation area 208 by maintaining contact with first component 220 and second component 240. This contact may be maintained as a result of the pressure differential between higher pressure region 204 and the area having the different pressure, which produces a pressure differential between a first lateral side 280 seal member 260 and a second lateral side 290 of seal member 260. Seal member may also be used to form a pressure isolation area 208, as will be discussed further herein. As illustrated, first component 220 and second component 240 represent a shell and a diaphragm, respectively, but it should be understood by those skilled in the art that first and second components 220, 240 could represent any stationary components within steam turbine 10 (FIG. 1) between which a seal is desired, including, but not limited to a shell, a diaphragm, a packing head, a casing, etc.

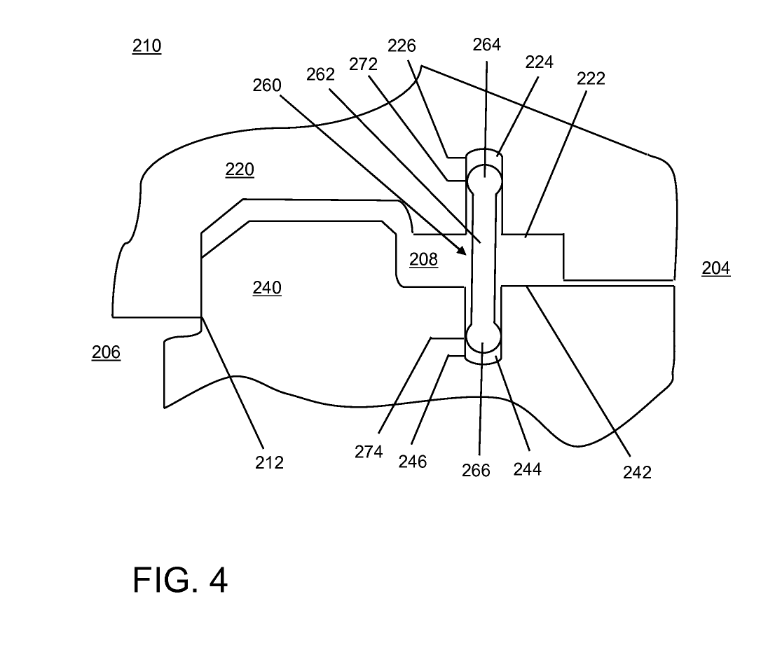

Turning now to FIG. 4, there is illustrated a cross section 210 of annular portion 200 (FIG. 3) of steam turbine 10 (FIG. 1). As illustrated, first component 220 has a radial surface 222. Within radial surface 222, is an annular groove 224, having an axial face 226. Similarly, second component 240 has an opposing radial surface 242. Within opposing radial surface 242 is an opposing annular groove 244 having an axial face 246.

Inserted within annular groove 224 of first component 220 and opposing annular groove 244 of second component 240 is seal member 260. As illustrated in cross section 210, seal member 260 has an elongated seal member 262, a first bulbous end 264, and a second bulbous end 266. Seal member 260 is designed such that first bulbous end 264 is adapted to be inserted into annular groove 224, and easily removed from annular groove 224, if needed, such as for maintenance or replacement. Similarly, seal member 260 is designed such that second bulbous end 266 is adapted to be inserted into annular groove 244, and easily removed therefrom if needed.

In any case, seal member 260 provides a seal between first component 220 and second component 240 with respect to higher pressure region 204 and pressure isolation area 208. This seal is maintained as a result of contact between first bulbous end 264 and axial face 226 of annular groove 224 forming a first point seal 272. Similarly, contact between second bulbous end 266 and axial face 246 of opposing annular groove 244 forms a second point seal 274. While first point seal 272 and second point seal 274 have been illustrated as being formed on axial faces 226 and 246, respectively, it should be understood that they may, in the alternative, be formed on the opposing axial faces, such as if the pressure of pressure isolation area 208 were greater that that of higher pressure region 204. In any case, the seal formed by point seals 272, 274 (hereafter “secondary steam joints”) maintains a pressure differential between higher pressure region 204 and pressure isolation area 208. Furthermore, the secondary steam joints formed by point seals 272, 274 may also work in conjunction with a primary steam joint 212 formed by an abutting of first component 220 and second component 240 in a region of cross section 210 that is located separate from seal member 260, to form pressure isolation area 208 between first component 220 and second component 240. Pressure isolation area 208 may serve one or more of multiple purposes, including but not limited to providing a region of isolated pressure and/or temperature to allow for internal component cooling or heating, flow path for steam used to actively provide sealing between stationary components and rotating components, or any other use envisioned in the art for an alternate conduit in a steam engine.

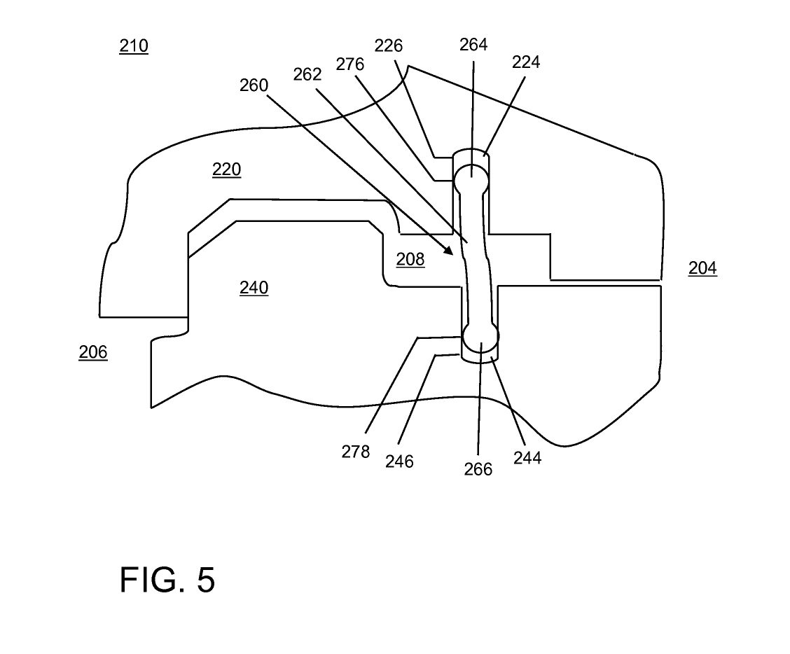

FIG. 5 provides an illustration of cross section 210 of annular portion 200 (FIG. 3) of steam turbine 10 (FIG. 1) under loading. As illustrated, aspects of first component 220 and second component 240 have changed relative to one another in such a way that annular groove 224 is offset from opposing annular groove 244. Such an offset may be caused, for example, by thermal forces that cause first component 220 to expand or contract at a rate that is different from that of second component 240. In any case, seal member 260 maintains the seal when such loading is applied. As shown, elongated seal member 262 is designed to flex in such a way that the secondary steam joints formed by first and second point seals 272, 274 is maintained. Furthermore, as first and second components 220, 240 change such that annular groove 224 is no longer aligned with opposing annular groove 244, first bulbous end 264 rotates to maintain contact with axial face 226 of annular groove 224, forming secondary first point seal 276. Similarly, second bulbous end 266 rotates to maintain contact with axial face 246 of opposing annular groove 244, forming secondary second point seal 278.

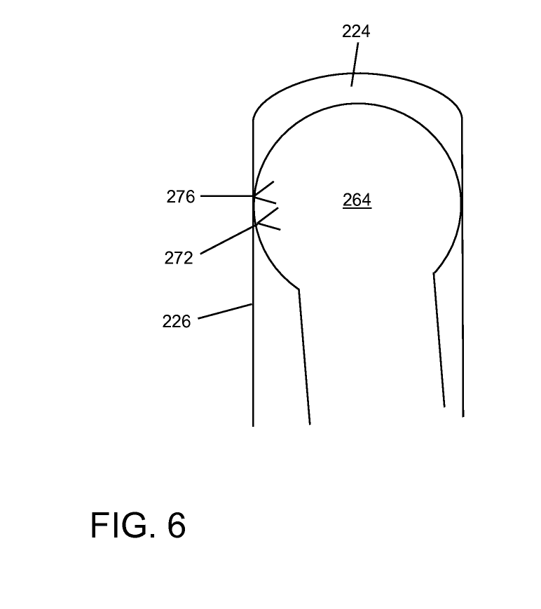

FIG. 6 further illustrates the maintaining of the point seal by the rotation of bulbous end 264 with respect to axial face 226 of annular groove 224. As illustrated, the change in alignment brought on by the loading in annular portion 210 (FIG. 5) has caused first point seal 272 to lose contact with axial face 226 of annular groove 224. Bulbous end 264 has rotated to form secondary first point seal 276 on a point of first bulbous end 264 that is different from that of first point seal 272 by rolling along the surface of axial face 226. In this way, seal member 260 ensures that a seal is maintained even when alignment changes between first component 220 and second component 240 in a manner that puts little or no stress on the seal itself.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A turbine comprising:
a first component, the first component having a radial surface with an annular groove;
a second component, the second component having an opposing radial surface in opposition to the radial surface of the first component, the opposing radial surface having an opposing annular groove; and
a seal member that is independent of the first and second components, the seal member being annular and having a cross section comprising an elongated seal member with first and second bulbous ends, the bulbous ends being adapted to be inserted into the annular groove and opposing annular groove to form a first point seal between the first bulbous end and an axial face of the annular groove and a second point seal between the second bulbous end and an axial face of the opposing annular groove.

2. The turbine of claim 1, the first and second components being substantially stationary within the steam turbine.

3. The turbine of claim 1, wherein the first and second components are selected from the group consisting of a shell, a diaphragm, a packing head, and a casing.

4. The turbine of claim 1, wherein the first and second bulbous ends maintain the first and second point seals in response to a realignment of the first component with respect to the second component by rotating with respect to the axial faces of the annular grooves.

5. The turbine of claim 4, wherein the first and second bulbous ends maintain the first and second point seals as a result of a flexing of the elongated seal member in response to a realignment of the first component with respect to the second component.

6. The turbine of claim 1, wherein the first and second bulbous ends are maintained in contact with the axial faces of the annular grooves via a pressure differential between a first lateral side of the seal member and a second lateral side of the seal member.

7. The turbine of claim 1, wherein the first and second components abut to form a primary steam joint that is separate from the first and second point seals, a combination of the primary steam joint and the first and second point seals forming a pressure isolation area between the first and second components.

8. The turbine of claim 7, wherein the pressure isolation area provides an isolated region that allows for at least one of internal component temperature control or a flow path for gasses used to actively provide sealing between stationary components and rotating components

9. The turbine of claim 1, wherein the turbine is a steam turbine.

10. The turbine of claim 9, wherein the steam turbine is one of a condensing steam turbine or a non-condensing steam turbine.

11. An annular seal member used in a steam turbine, the annular seal member having a cross section, the annular seal member comprising:
an elongated body;
a first bulbous end coupled to the elongated body, the first bulbous end being adapted to be inserted into an annular groove in a radial surface of a first component; and
a second bulbous end coupled to the elongated body, the second bulbous end being adapted to be inserted into an opposing annular groove in an opposing radial surface of a second component, the opposing radial surface being in opposition to the radial surface of the first component,
wherein the elongated body, the first bulbous end and the second bulbous end are independent of the first and second components, and
wherein a contact between the first bulbous end and an axial face of the annular groove forms a first point seal between the first bulbous end and the axial face of the annular groove and wherein a second contact between the second bulbous end and an axial face of the opposing annular groove forms a second point seal between the second bulbous end and the axial face of the opposing annular groove.

12. The annular seal member of claim 11, wherein the first and second bulbous ends maintain the first and second point seals by rotating with respect to the axial faces of the annular grooves in response to a realignment of the first component with respect to the second component.

13. The annular seal member of claim 11, wherein the first and second bulbous ends maintain the first and second point seals as a result of a flexing of the elongated seal member in response to a realignment of the first component with respect to the second component.

14. The annular seal member of claim 11, wherein the first and second bulbous ends are maintained in contact with the axial faces of the annular grooves via a pressure differential between a first lateral side of the seal member and a second lateral side of the seal member.
